(19) United States
(12) Patent Application Publication
(10) Pub. No.: US 2002/0019677 A1
(43) Pub. Date: Feb. 14, 2002

(54) Method for providing personal golf record information using the internet

(76) Inventor: Jae Woo Lee, Seoul (KR)

Correspondence Address: HARNESS, DICKEY & PIERCE, PLC, P.O. BOX 828, BLOOMFIELD HILLS, MI, 48303, US

(21) Appl. No.: 09/826,567

(22) Filed: Apr. 5, 2001

(30) Foreign Application Priority Data
Aug. 9, 2000 (KR) P2000-46201

(51) Int. Cl. G06F 155/00

(52) U.S. Cl. 700/91

(57) ABSTRACT

The present invention relates to a method for providing information through the internet, and more particulary to a method for providing personal golf record information using the internet, capable of providing the personal record information of golfers in the field by using the internet.

According to the present invention, the method for providing the personal golf record information through the internet comprises steps of receiving, databasing, and storing personal record information of golfers through a communication network by means of a server for providing golf game record information; transferring a log-in screen for login as users are connected; providing the users with a list of the stored personal golf record information of the users to have the users select games they want for a transfer of the personal record information; transferring a hole selection screen to have the users select holes as the users select a game they want from the list of the personal record information; and providing topological map graphics of the selected holes and providing a game record of the users on the provided topological map graphics.

### BACKGROUND OF THE INVENTION

1. Field of the Invention

The present invention relates to a method for providing golf information through the internet, and more particularly to a method for inputting golfers' play results in golf courses, converting the results into digital data, and providing the data through the internet, by using a GPS terminal of displaying a remaining distance and the like during a round of golf

2. Description of the Related Art

In recent, the population enjoying golf which is taking a place as public sports in earnest tends to increase day by day.

In general, golfers during a round of golf choose a golf club fit for a remaining distance from a position at which a ball is located to a pin, wind direction and intensity, topographical shapes to a hole, and so on. For example, a male amateur golfer having average ability and flight distance, when influences of wind and topological shapes are not taken into consideration, selects clubs getting smaller in loft angles and longer in shaft lengths as the distance gets farther, such as the 7^{th} iron in case of 150 yards in remaining distance, the 6^{th} iron in case of 160 yards, the 8^{th} iron in case of 140 yards, and so on.

Accordingly, a remaining distance from a ball position to a pin is a considerably important factor in playing, which is indicated in a different way in every golf course but can be referred to with yardage poles mounted at 200 yard, 150 yard, 100 yard, and so on in usual or referred to a yardage book able to be obtained in a store in a corresponding course. Further, in case that a caddie is accompanied, advice can be obtained for the distance.

In the meantime, according to the advancements of commercialized GPS technologies which enable locations to be grasped through communications with artificial satellites, the technologies are increasingly used for golf. Usually, a GPS terminal is installed in a power cart, so that a golfer can grasp all sorts of information, including remaining distances and the like, helpful in playing in more detailed and precise ways. However, the GPS terminal itself is so expensive that its application is limited to relatively high-class golf courses so far rather than popularized. In particular, in case of golf courses in oriental regions prohibiting an entrance of a power cart to a fairway, there are many cases that the GPS terminal is not helpful in real playing since a considerable distance difference exists between a location of the cart and a ball position. U.S. Pat. No. 5,434,789 entitled “GPS golf diagnostic system”, U.S. Pat. No. 5,944,132 entitled “Method and apparatus for controlling robotic golf caddy apparatus”, and so on have disclosed the GPS for golf. In particular, the U.S. Pat. No. 5,434,789 has disclosed a method and so on for obtaining distances from previous ball positions, a green position or a pin position to a present ball position in detail.

In the meantime, golfers directly calculate their own playing contents, primarily the number of strokes in every corresponding hole and record score cards. The score cards so recorded are kept and retained for a long period of time in commemoration, or referred to for the purposes of studies for a hole attack method when playing another round on the same course according to characters or preferences of the golfers, but discarded on the spot in most cases.

Accordingly, the present invention has been devised to cope with the above necessity, so it is an object of the present invention to provide a method for providing personal record information using the internet, enabling golfers to record personal record information by using mobile phones in which GPS terminals or GPS chips are built and to store the recorded personal record information through upload by using a communication network, and enabling to provide the personal record information through personal computers as well as the mobile phones capable of being connected to the internet in case that individuals are connected through the internet and want the providing of the stored personal record information.

In order to achieve the above object, the present invention comprises steps of receiving, databasing, and storing personal record information of golfers through a communication network by means of a server for providing golf game record information; transferring a log-in screen for login as users are connected; providing the users with a list of the stored personal golf record information of the users to have the users select games they want for a transfer of the personal record information; transferring a hole selection screen to have the users select holes as the users select a game they want from the list of the personal record information; and providing topological map graphics of the selected holes and providing a game record of the users on the provided topological map graphics.

Further, the present invention comprises steps of receiving, databasing, and storing personal record information of golfers by means of a server for providing golf game record information; transferring a log-in screen for login as users are connected; selecting golf links by transferring a golf links selection screen; providing a list of game records of a game proceeded in the selected golf links as the golf links is selected; and selecting holes by transferring a hole selection screen according to the selection of a game a golfer wants for a transfer of the personal record information in the list of the game records; and providing the personal game record information for the selected holes.

### BRIEF DESCRIPTION OF THE DRAWINGS

The above object and other advantages of the present invention will become more apparent by describing in detail a preferred embodiment thereof with reference to the attached drawings, in which:

FIG. 1 is a view for showing an appearance of a GPS terminal used for an embodiment of the present invention;

FIG. 2 is a conceptional view for showing a method for providing personal golf record information through the internet according to an embodiment of the present invention;

FIG. 3 is a view for showing an apparatus for providing personal golf record information through the internet according to an embodiment of the present invention;

FIG. 4 is a view for showing the samples of recording paper used for an embodiment of the present invention;

FIG. 5a to FIG. 5e are views for showing web pages provided to users of the present invention;

FIG. 6 is a flow chart for showing a method for providing personal golf record information through the internet according to an embodiment of the present invention; and

FIG. 7 is a flow chart for showing a method for providing personal golf record information through the internet according to another embodiment of the present invention.

### DETAILED DESCRIPTION OF THE PREFERRED EMBODIMENT

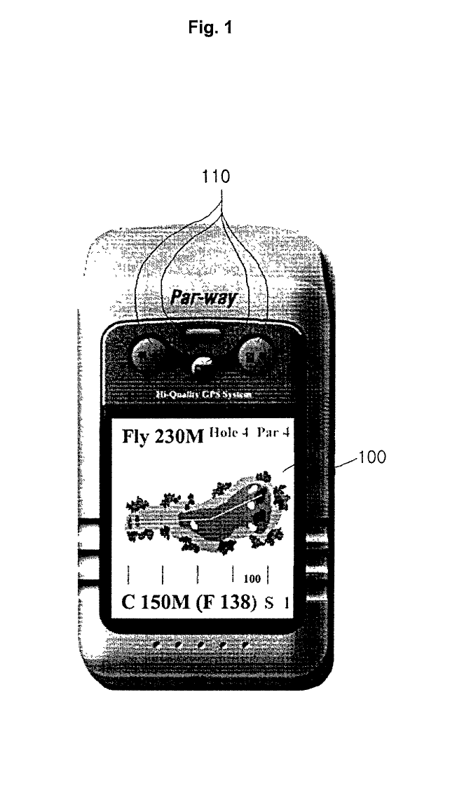

Hereinafter, a preferred embodiment of the present invention will be described in detail with reference to the accompanying drawings beginning with FIG. 1.

In the drawings, FIG. 1 is a view for showing the appearance of a GPS terminal used for an embodiment of the present invention.

As shown in FIG. 1, the GPS terminal used for the embodiment of the present invention is equipped with a screen 100 and a plurality of buttons 110.

A distance to be reached to a pin is indicated on the lower left side of the screen 100, the number of shots by hole is indicated on the lower right side, topological map graphics by hole is indicated on the center, satellite sensitivity and battery remained are indicated on the upper left side, and a hole number is indicated on the upper right side. Here, grid lines are indicated in the topological map graphics by 50 M unit to provide distance information left to a bunker and a water hazard.

The buttons 110 include a power button for supplying electric power, an input button for providing the storage of shots and information on distance left from a present position to a pin, a cancel button capable of canceling input contents, and a next hole button for providing movements to a next hole.

A golfer can lease the GPS terminal from the front desk and the like of a golf course, and the leased GPS terminal stores plane layouts(plane graphs) of individual golf courses or cross-sectioned layouts of showing the up and down of the entire golf courses, which are GPS-measured by using air photos or design drawings when completing the golf courses. At this time, a golfer bearing the GPS terminal uses his personal computer at home or in his office to input, for use, the plane outlays of the individual golf courses or the cross-sectioned layouts of showing the up and down of the entire golf courses of golf links downloaded from a web service server. Further, the plane layouts of the individual golf courses, the cross-sectioned layouts of showing the up and down of the entire golf courses, or the like, of the golf links can be inputted, for use, from the web service through a mobile communication terminal(for example, a personal mobile communication terminal, PDA, and so on) accessible to the internet in a wireless way. Furthermore, at this time, the web service server provides information on whether a green to be used on the day or on the date of a game is an A type or a B type, and provides information on a hole to be started with, that is, information on the out courses and the in courses.

Further, if a golfer selects a corresponding hole and presses buttons at a start point and at an end point of each shot in the selected hole while proceeding with a game at a field, the GPS terminal automatically and linearly links the start point and the end point of a shot and shows a result of the game. Furthermore, the GPS terminal shows information on a flight distance, a distance left to a hole cup, positions of a bunker and a water hazard, and so on in a graphic way. At this time, when a hole-in is made in the hole cup, the golfer selects a corresponding button to input the fact, enabling the GPS terminal to record a game proceeding result more precisely to thereby manage the game score.

In the meantime, the golfer can be provided with location information through a mobile phone in which a GPS chip is built. A bearer of the mobile phone in which the GPS chip is built can input the graphs of the plane layout of the individual golf courses and the entire cross-sectioned layout plane view of showing the up and down of the entire golf courses for use at the front desk and the like, and input the plane layouts (plane graph) of the individual golf courses of a golf links, the cross-sectioned layouts of showing the up and down of the entire golf courses, or the like, for use, by directly connecting to a web service server in a wireless way.

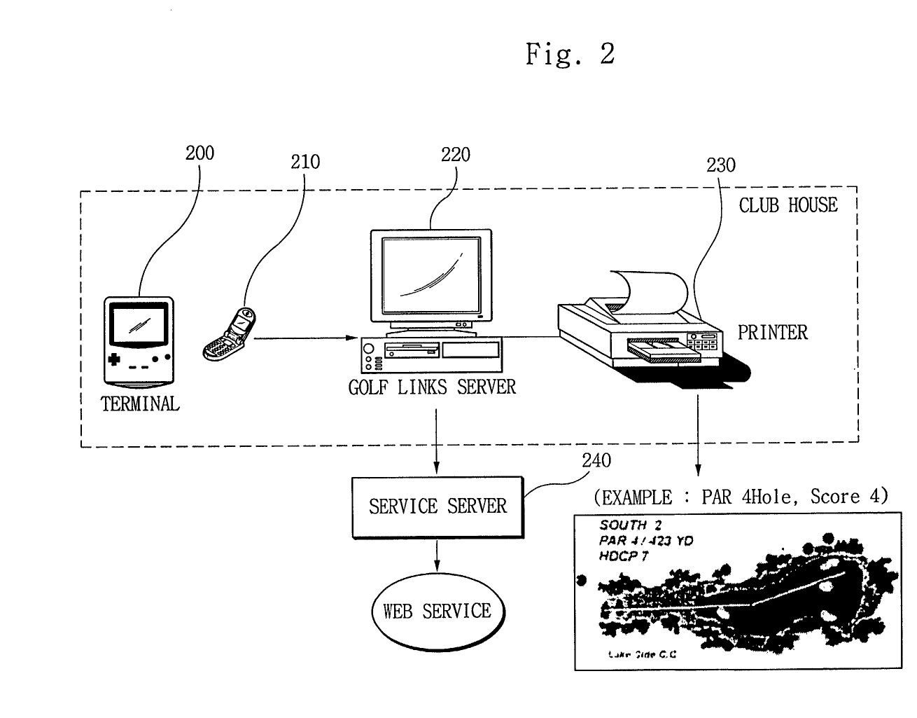

In the drawings, FIG. 2 is a conceptional view for showing a method for providing personal golf record information through the internet according to an embodiment of the present invention.

As shown in FIG. 2, after a golfer finishes a game in field, if the golfer leaves or returns the GPS terminal 200 on or to the front desk, an administrator of the golf links on the front desk connects the GPS terminal 200 to a golf links server 220 by using a download station (not shown) to receive personal record information from the GPS terminal 200.

Further, the golf links server 220 outputs the received personal record information by using an equipped printer 230. At this time, the golf links server 220 calculates a position correction value based on an absolute position value stored therein by receiving position information for every hour from a GPS satellite and outputs personal record information according to a position value corrected after correcting a position by using the calculated position correction value, that is, to enable the golf links server 220 to obtain a precise position value by having the golf links server 220 performed as a DGPS system. Further, the golf links server 220 stores in a database the personal record information received from the GPS terminal 200, and, at this time, stores the personal record information according to the corrected position value based on the position correction value.

Next, the golf links server 220, after connecting to the internet, uploads the personal record information transferred from the GPS terminal 200 by connecting to a web service server 240 for providing the personal record information.

A golfer who personally has the GPS terminal 200 uploads the personal record information to his personal computer through the download/upload station at home, in his office, and so on, connects the personal computer to the web service server 240 through the internet, and enables the personal computer to upload his personal record information which has been uploaded to the web service server 240. Further, the golfer can transfer the personal record information stored in the GPS terminal 200 to the web service server 240 through the internet in a wireless way.

Next, the service server 240 stores the uploaded personal record information, and, if an individual requests the stored personal record information, provides the corresponding personal record information.

In the meantime, a bearer of the mobile phone 210 in which the GPS chip is built can transfer personal record information to the golf links server 220 by connecting to the golf links server 220 on the front desk after finishing a golf game, and print the personal record information by using a printer 230. Further, the procedures progressed by the golf links server 220 as the same as stated above.

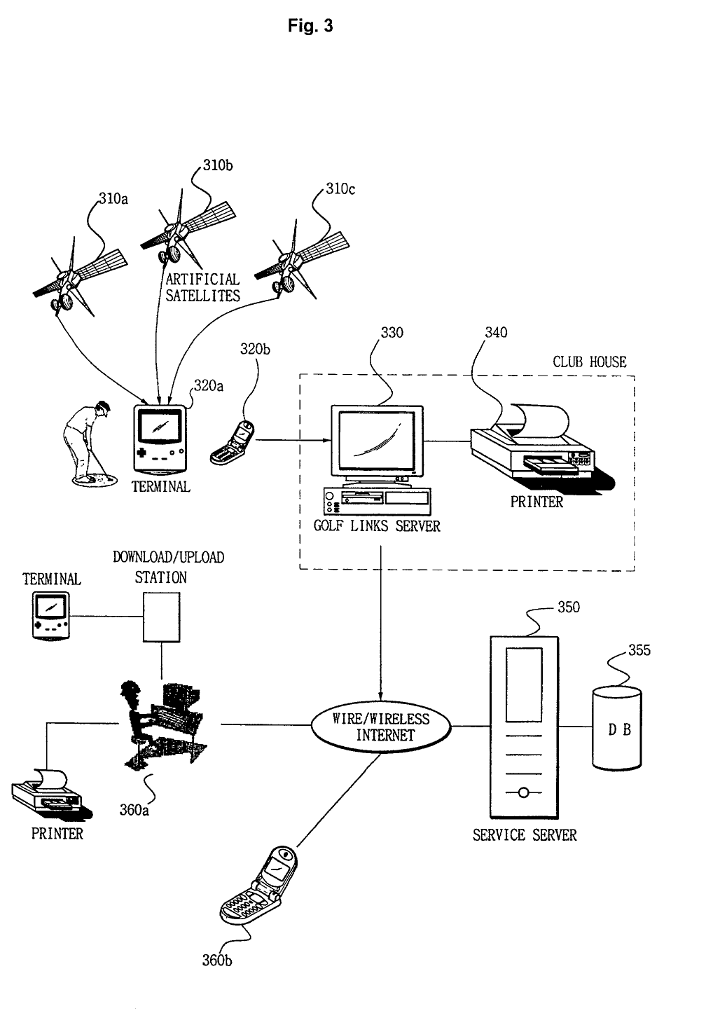

In the drawings, FIG. 3 is a view for showing a state of network connections for a method for providing personal golf record information through the internet according to an embodiment of the present invention.

As shown in FIG. 3, the network connection state for a method for providing personal golf record information through the internet according to an embodiment of the present invention includes a plurality of artificial satellites 310a to 310c, a GPS terminal 320a, a mobile phone 320b in which a GPS chip is built, a golf links server 330, a printer 340, a service server 350, a database 355, and a personal computer 360a as a client device or a mobile phone 360b able to connect to the internet.

First of all, a golfer carries the mobile phone 320b in which the GPS chip is built with him, or leases and carries with him the GPS terminal 320a from the front desk of a corresponding golf links, and proceeds with a game in the field. At this time, graphics about respective holes of the corresponding golf links are stored in a plane or stereophonic way in the terminal 320a, the bearer of the mobile phone 320b in which the GPS chip is built downloads the graphics about the respective holes of the corresponding golf links in a plane or stereophonic way from the front desk and the like for storage. The bearer of the mobile phone 320b in which the GPS chip is built can download the graphics about the respective holes of the golf links in a plane or stereophonic way from the service server 350 directly through the wireless internet or through the internet. Further, the bearer of the GPS terminal 320a can, as shown, download the graphics about the respective holes of the golf links from the service server 350 in a plane or stereophonic way through the internet or through the wireless internet by using a personal computer and a downloading/uploading station at home, in office, or the like.

Furthermore, a golfer records the game contents by pressing buttons at a start point and at an end point of a shot while proceeding with the game. At this time, the terminal 320a or the mobile phone 320b in which the GPS chip is built receives data about corresponding positions from the artificial satellites 310a to 310c, stores a locus of the shot on the stored graphics of the holes, and provides information necessary for the game progress.

After the game is finished, a golfer returns the terminal 320a he carries with to the front desk or the like or hands over the GPS chip-built-in mobile phone 320b he carries with to the front desk or the like, so the terminal 320a or the GPS chipbuilt-in mobile phone 320b is connected to the golf links server 330 which are administered in the golf links through the downloading station(not shown) to transfer the game record to the golf links server 330.

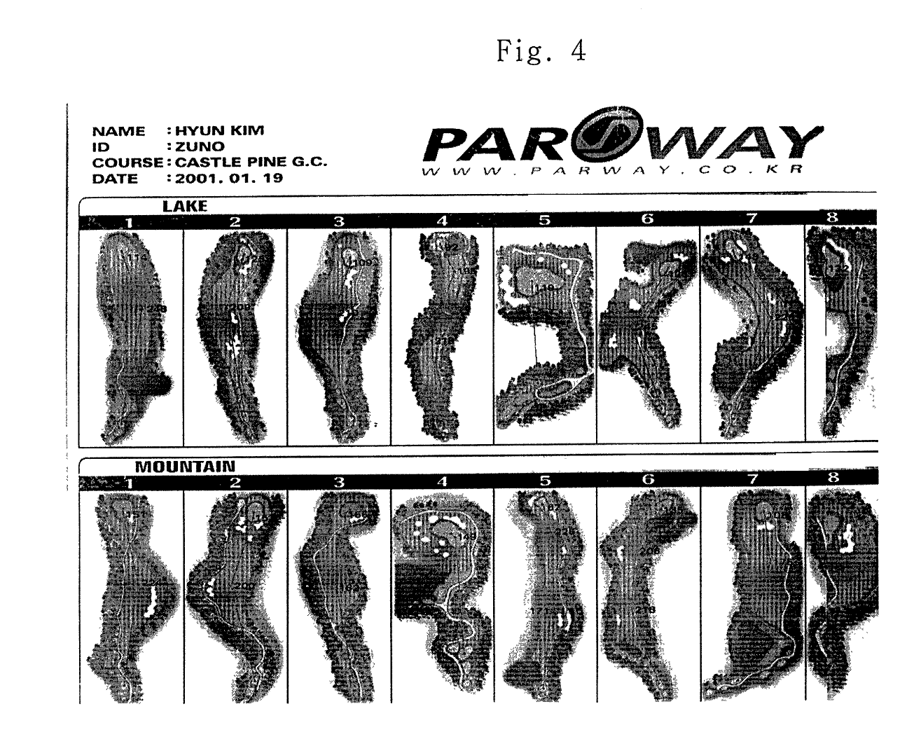

Accordingly, the golf links server 330 prints the game record results by using the printer 340 and provide the golfer with the printed results. Samples of the record paper provided at this time are shown in FIG. 4. At this time, the golf links server 330 is performed as a DGPS system to calculate a position correction value, corrects the personal record information based on the calculated position correction value, and outputs the corrected personal record information by using the printer 340. Further, flight distances by shots are indicated on the record papers inside the plane graphics or the stereophonic graphics of the golf links, and advertisements can be printed on both sides or the lower portion of the record paper. The flight distances by shots can be indicated on a side over or below the graphics of the record paper.

Thereafter, the golf links server 330 connects to the service server 350 through the internet and transfers the received personal record information together with personal information, and the service server 350 which receives the personal record information and the personal information databases the personal record information received in the record information database 355 of the corresponding individual based on the received personal information.

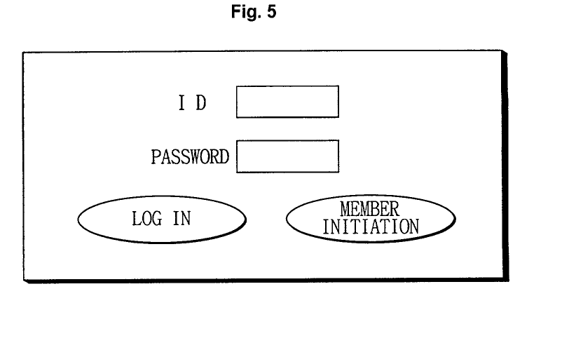

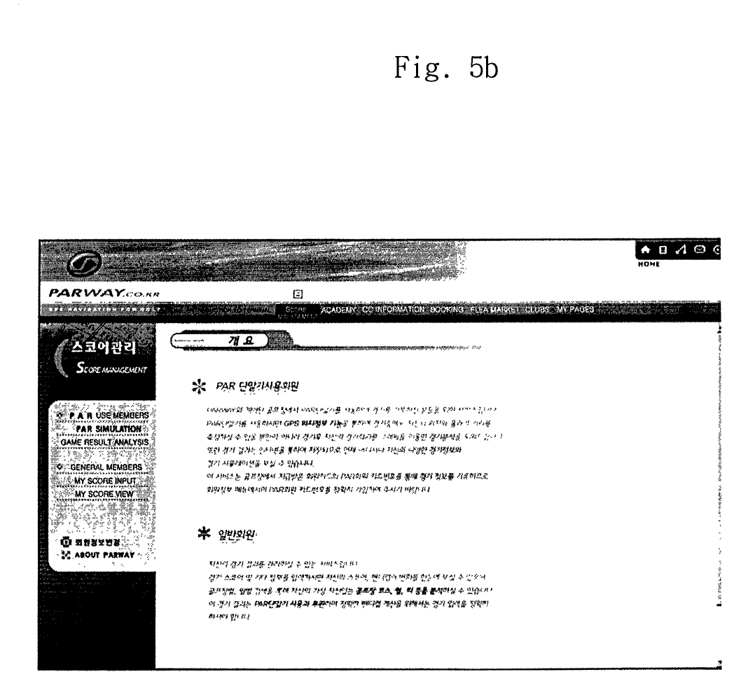

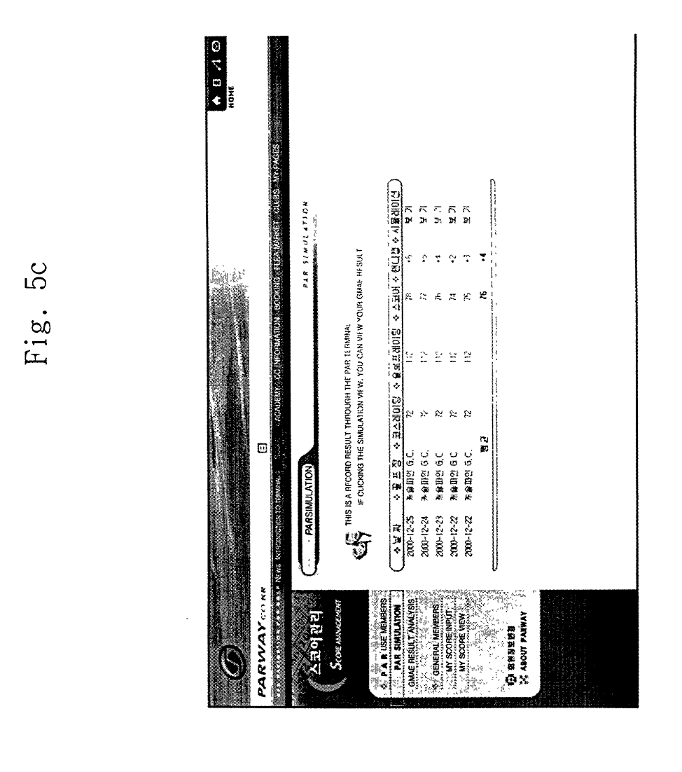

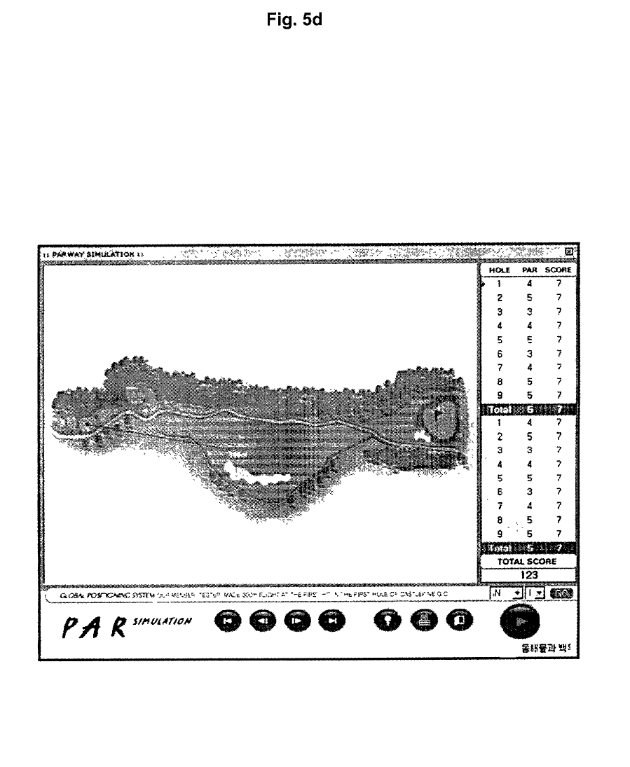

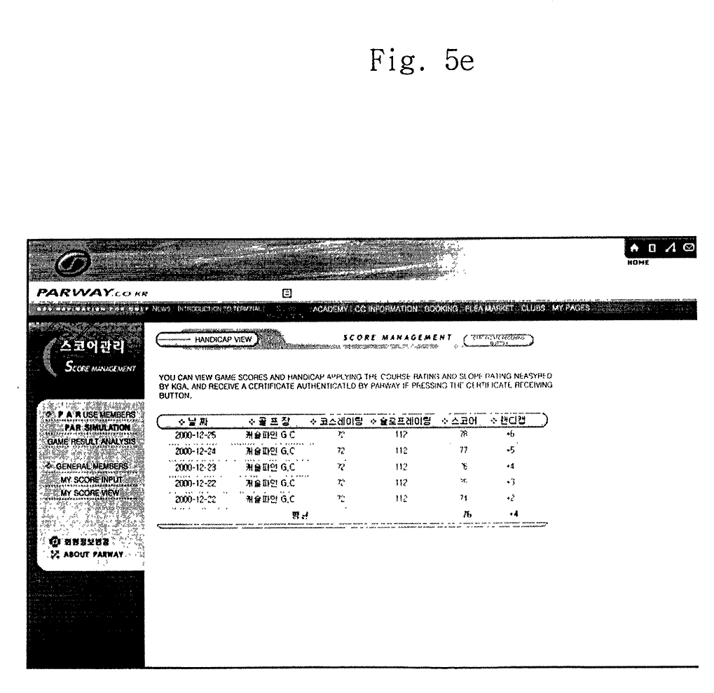

Next, if the golfer connects to a service server 350 through a client device, that is, a personal computer 360a or a mobile phone 360b in which the GPS chip is built at home, in his office, or the like, the service server 350 transfers a login screen as shown in FIG. 5a for login.

At this time, in case that a golfer is not initiated into a member, a member initiation web page is provided for the golfer to be initiated into a member, and then the login screen is provided for the golfer to be logged in.

Further, a service list available is provided for the logged-in member to select desired services. At this time, on the service list to be provided are a par simulation service, a game result analysis service, and so on, and an example of the screen provided is shown in FIG. 5b.

As shown in FIG. 5b, classification is made into PAR use members (here, means GPS terminal use members) and general members, and the PAR simulation service and the game result analysis service are provided for the GPS terminal use members and a my score input service and a my score view service can be provided for the general members.

If a member selects the PAR simulation service, as shown in FIG. 5c, a game record list using the GPS terminal is provided, and, if the member clicks a game record list he wants to view in the provided game record list, the PAR simulation service get provided. The example can be seen in FIG. 5d.

As shown in FIG. 5d, a table is provided on the right side of the screen, in which hole numbers, PAR, and scores are provided. If a member selects a hole number he wants to view, a hole graphics according to the selection is provided on the center of the screen.

Further, on the lower side of the screen are provided a start view button which can move a golf ball to an initial position, a previous button which can move the golf ball to a previous position, an automatic view button which can automatically move the golf ball, a next button which can move the golf ball to a next position, a last button which can move the golf ball to the last, and an optimum attack map view button which shows an optimum course in attacking a hole.

Members can view their game record results again by using the above buttons as well as the optimum attack map of a hole.

Next, by selecting the game result analysis service, members can be provided with analysis materials such as an average driver distance, a fairway hit rate, an average putting number, longest shot, and so on. On a upper side of the screen provided at this time is provided a handicap view screen as shown in FIG. 5e. At this time, the handicaps are provided to members who want them by calculating official handicaps in association with the Korea Golfers Association(KGA).

Further, on the screen for providing the game result analysis service is provided a certificate receiving button which is linked to a certificate issue web page which issues certificates, so members who want to receive certificates can receive certificates if clicking the certificate receiving button.

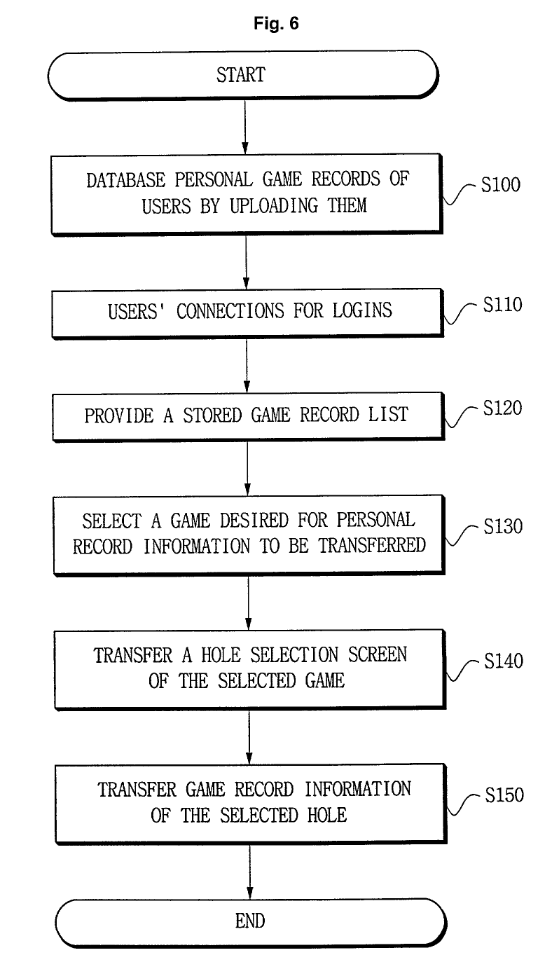

In the drawings, FIG. 6 is a flow chart for showing a method for providing personal golf record information through the internet according to an embodiment of the present invention.

First of all, after receiving and storing in a database personal game records of users S100, a login screen is transferred for login as users are connected through personal computers or internet-accessible mobile phones. At this time, if the users are not initiated into members, the users get logged in after initiated into members S110.

Next, the stored personal record information list is provided S120, a game desired for personal record information to be transferred is selected S130, a hole of the selected game is selected S140, the game record information according to the selected hole is transferred S150. At this time, the provided game record information includes a topological map graphics, a locus of a golf ball is indicated on the topological map graphics, and various buttons are equipped to provide an automatic view function, an optimum attack locus view function, and so on.

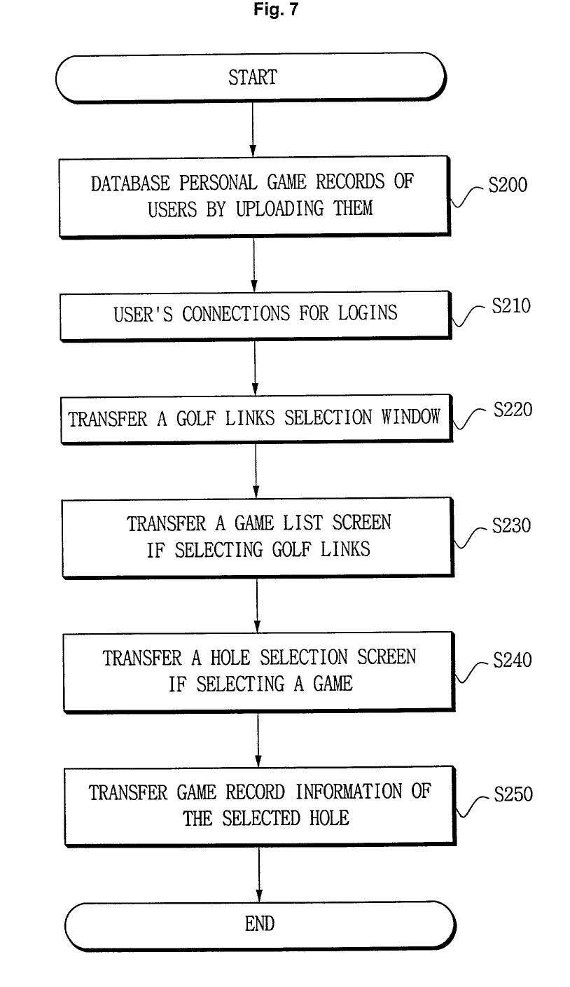

In the drawings, FIG. 7 is a flow chart for showing a method for providing personal golf record information through the internet according to another embodiment of the present invention.

First of all, after receiving, databasing, and storing golfers' personal game records S200, a login screen is transferred for login as users are connected through personal computers or internet-accessible mobile phones, and, as the users are logged in S210, a golf links selection window is transferred S220.

Thereafter, if the users select golf links, the window provides a game list proceeded in the selected golf links or let the users select dates S230. If the users select a game in the game list or select a game date, a hole selection screen is transferred to select a hole S240. Next, the personal record information of the selected hole is transferred S250.

According to the present invention, an effect is obtained in that internet users can receive their game record contents about every game in golf links at his home, in his office, or the like and use the contents as analysis materials before playing golf.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A method for providing personal golf record information using the internet, comprising the steps of:
receiving, databasing, and storing personal record information of golfers through a communication network by means of a server for providing golf game record information;
transferring a log-in screen for login as users are connected;
providing the users with a list of the stored personal golf record information of the users to have the users select games they want for a transfer of the personal record information;
transferring a hole selection screen to have the users select holes as the users select a game they want from the list of the personal record information; and
providing topological map graphics of the selected holes and providing a game record of the users on the provided topological map graphics.

2. The method as claimed in claim 1, further comprising the steps of:
providing a web page equipped with a plurality of game analysis result buttons linked to web pages for providing the users with game analysis results; and
providing analysis materials from a group including an average driver distance, a fairway hit rate, an average putting number, and a longest shot if the users click the game analysis result button.

3. The method as claimed in claim 1, wherein the step for receiving the game record information of the golfers includes the steps of:
receiving position information from GPS satellites by means of GPS terminals and recording game contents on the hole topological map graphics by pressing input buttons equipped on the GPS terminals at start and end points of a shot during games by the users bearing the GPS terminals which store entire topological map graphics for holes;
transferring the game record to a golf links server by connecting the GPS terminals in which the game record in the step of receiving position information from GPS satellites is stored to the golf links server; and
transferring the personal record information and personal information by connecting the golf links server to the server for providing the golf game record information through the internet.

4. The method as claimed in claim 1, wherein the step for receiving the game record information of the golfers includes the steps of:
receiving position information from GPS satellites by means of GPS terminals and recording game contents on the hole topological map graphics by pressing input buttons equipped on the GPS terminals at start and end points of a shot during games by the users bearing the GPS terminals which store entire topological map graphics for holes; and
transferring the personal game record information to the server for providing the golf game record information by connecting the GSP terminals in which the game record in the step of receiving the position information from GPS satellites is stored from personal computers to the server for providing the golf game record information through the internet.

5. The method as claimed in claim 3, wherein the step for the GPS terminals to store the entire topological map graphics for the holes receives and stores the entire topological map graphics for the holes from the golf links server by connecting to the golf links server.

6. The method as claimed in claim 4, wherein the step for the GPS terminals to store the entire topological map graphics for the holes receives and stores the entire topological map graphics for the holes from the golf links server by connecting to the golf links server.

7. The method as claimed in claim 3, wherein the step for the GPS terminals to store the entire topological map graphics for the holes receives and stores the entire topological map graphics for the holes by using personal computers and connecting to the server for providing the golf game record information.

8. The method as claimed in claim 4, wherein the step for the GPS terminals to store the entire topological map graphics for the holes receives and stores the entire topological map graphics for the holes by using the personal computers and connecting to the server for providing the golf game record information.

9. The method as claimed in claim 3, wherein the step for the GPS terminals to store the entire topological map graphics for the holes receives and stores the entire topological map graphics for the holes by connecting mobile communication terminals by which a wireless internet service is available to the server for providing the golf game record information through a wireless internet network.

10. The method as claimed in claim 4, wherein the step for the GPS terminals to store the entire topological map graphics for the holes receives and stores the entire topological map graphics for the holes by connecting mobile communication terminals by which a wireless internet service is available to the server for providing the golf game record information through a wireless internet network.

11. The method as claimed in claim 3, further comprising a step of:
printing the personal game record information from the golf links server through a printer.

12. The method as claimed in claim 4, further comprising a step of:
printing the personal game record information from the golf links server through a printer.

13. The method as claimed in claim 12, wherein, in printing the personal game record information from the golf links server, the golf links server calculates position correction values by using absolute position values and position values received from the GPS satellites, and correcting and outputting the personal record information by using the calculated position correction values.

14. The method as claimed in claim 1, wherein, in providing the game record the server for providing the golf game record information receives position correction values calculated by using absolute position values from the golf links server and position values transferred from the GPS satellites, and corrects and transfers the personal record information by using the transferred position correction values.

15. The method as claimed in claim 1, wherein, in providing the game record provided are a PREVIOUS button for moving back a golf ball to a previous position, an AUTOMATIC VIEW button for automatically moving the golf ball, a NEXT button for moving the golf ball to a next position, a LAST button for moving the golf ball to the last, and an OPTIMUM ATTACK MAP VIEW button for showing an optimum course in attacking a hole, and provided are corresponding functions according to the selected buttons as the users select desired buttons.

16. The method as claimed in claim 1, wherein the step for receiving the game record information of the golfers includes the steps of:
receiving position information from GPS satellites by means of mobile communication terminals and recording game contents on the hole topological map graphics by pressing input buttons equipped on the mobile communication terminals at start and end points of a shot during games by the users bearing the mobile communication terminals in which a GSP chip is built and which store entire topological map graphics for holes;
transferring the game record to a golf links server by connecting the mobile communication terminals in which the GSP chip is built and in which the game record in the step of receiving position information from GPS satellites is stored to the golf links server; and
transferring the personal record information and personal information by connecting the golf links server to the server for providing the golf game record information through the internet.

17. The method as claimed in claim 1, wherein the step for receiving the game record information of the golfers includes the steps of:
receiving position information from GPS satellites by means of mobile communication terminals in which GPS chips are built and recording game contents on the hole topological map graphics by pressing input buttons equipped on the mobile communication terminals at start and end points of a shot during games by the users bearing the mobile communication terminals which store entire topological map graphics for holes; and
transferring the personal game record information to the server for providing the golf game record information by connecting the mobile communication terminals in which the game record in the step of receiving position information from GPS satellites is stored from personal computers to the server for providing the golf game record information through the wireless internet/the internet.

18. The method as claimed in claim 16, wherein the step for the mobile communication terminals in which the GPS chips are built to store the entire topological map graphics for the holes receives and stores the entire topological map graphics for the holes from the golf links server by connecting to the golf links server.

19. The method as claimed in claim 17, wherein the step for the mobile communication terminals in which GPS chips are built to store the entire topological map graphics for the holes receives and stores the entire topological map graphics for the holes from the golf links server by connecting to the golf links server.

20. The method as claimed in claim 16, wherein the step for the mobile communication terminals in which GPS chips are built to store the entire topological map graphics for the holes receives and stores the entire topological map graphics for the holes through a wireless internet network by connecting to the long server for providing the golf game record information.

21. The method as claimed in claim 17, wherein the step for the mobile communication terminals in which GPS chips are built to store the entire topological map graphics for the holes receives and stores the entire topological map graphics for the holes through a wireless internet network by connecting to the server for providing the golf game record information.

22. The method as claimed in claim 16, further comprising a step of:
printing the personal game record information from the golf links server through a printer.

23. The method as claimed in claim 17, further comprising a step of:
printing the personal game record information from the golf links server through a printer.

24. The method as claimed in claim 23, wherein, in printing the personal game record information from the golf links server, the golf links server calculates position correction values by using absolute position values and position values received from the GPS satellites, and correcting and outputting the personal record information by using the calculated position correction values.

25. A method for providing personal golf record information using the internet, comprising the steps of:
receiving, databasing, and storing personal record information of golfers by means of a server for providing golf game record information;
transferring a log-in screen for login as users are connected;
selecting golf links by transferring a golf links selection screen;
providing a list of game records of a game proceeded in the selected golf links as the golf links is selected; and
selecting holes by transferring a hole selection screen according to the selection of a game a golfer wants for a transfer of the personal record information in the list of the game records; and
providing the personal game record information for the selected holes.
